(19) United States
(12) Patent Application Publication
(10) Pub. No.: US 2026/0104179 A1
(43) Pub. Date: Apr. 16, 2026

(54) SOUND REDUCTION FAN INLET

(71) Applicant: Broan-NuTone LLC, Hartford, WI (US)

(72) Inventors: Marco Lizotte, Saint-Louis-De-Blandford (CA); Santosh Narasimhan, Port Washington, WI (US); Patrick Bouché, Sherbrooke (CA); Brent Lillesand, Milwaukee, WI (US); Jean-Bernard Piaus, Drummondville (CA); Rick Sinur, Hartford, WI (US); Raymond Panneton, Sherbrooke (CA)

(21) Appl. No.: 19/415,381

(22) Filed: Dec. 10, 2025

Related U.S. Application Data
(63) Continuation-in-part of application No. 18/330,615, filed on Jun. 7, 2023, now Pat. No. 12,523,394.
Application No. 18/330,615 is a continuation-in-part of application No. 17/737,153, filed on May 5, 2022, now Pat. No. 11,680,731.
Application No. 17/737,153 is a continuation of application No. 16/553,456, filed on Aug. 28, 2019, now Pat. No. 11,353,239.

(51) Int. Cl. F24F 13/24; G10K 11/162

(52) U.S. Cl. CPC F24F 13/24; G10K 11/162; F24F 2013/242

(57) ABSTRACT

A ventilation assembly includes a ventilation grille having acoustic bodies configured and situated to attenuate sound of the ventilation assembly. Arrangement of the acoustic bodies can form phononic crystals that can be tuned to desired sound bands and reduce sound.

### RELATED APPLICATIONS

This Application is a continuation-in-part of U.S. application Ser. No. 18/330,615, filed on Jun. 6, 2023, which is a continuation-in-part of U.S. application Ser. No. 17/737,153, filed on May 5, 2022, which is a continuation of U.S. application Ser. No. 16/553,456, filed on Aug. 28, 2019, each of which is incorporated in its entirety herein by reference and made a part hereof.

### TECHNICAL FIELD

The present disclosure relates to devices, systems, and methods for sound reducing grilles and other air flow systems. More particularly, but not exclusively, the present disclosure relates to devices, systems, and methods for grilles for use in ventilation of enclosed rooms.

### BACKGROUND

Ventilation is commonly applied to maintain desirable air conditions within confined spaces. For example, common households may include ventilation devices and/or systems for rooms having sinks or bath fixtures that use water to remove excess humidity, noxious odors or other pollutants from the room. Ventilation can require moving parts to draw air which can create vibrations and/or sound, yet, reducing excess vibration and/or sound can require costly upgrades to component parts. Accordingly, there is a need for improved ventilation with reduced vibrations and/or sound.

### SUMMARY

In accordance with an aspect of the present disclosure, a ventilation system comprises a main housing defining an inlet through which air can be received into the main housing and defining an outlet; a blower in the main housing operable to generate a flow of air; a grille configured to be located adjacent to the main housing inlet, the grille comprising a plate having an outermost edge, wherein the plate defines an outlet aperture; a pair of guide vanes extending from adjacent to the outermost edge of the plate toward the outlet aperture, the guide vanes defining a flow path; an outer acoustic body located in the flow path and an inner acoustic body located in the flow path. The outer acoustic body can be located adjacent to the plate outermost edge. The inner acoustic body can be located adjacent to the outlet aperture. The outer acoustic body and the inner acoustic body can define an acoustic feature. The acoustic feature can be a phononic crystal. At least one of the guide vanes can define a curvilinear path from the plate outermost edge to the outlet aperture.

A grille for ventilation assembly is disclosed comprising a plate having an outermost edge, wherein the plate defines an outlet aperture; a pair of guide vanes extending from adjacent to the outermost edge of the plate toward the outlet aperture, the guide vanes defining a flow path; an outer acoustic body located in the flow path and an inner acoustic body located in the flow path. The outer acoustic body can be located adjacent to the plate outermost edge. The inner acoustic body can be located adjacent to the outlet aperture. The outer acoustic body and the inner acoustic body can define an acoustic feature. The acoustic feature can be a phononic crystal. At least one of the guide vanes can define a curvilinear path from the plate outermost edge to the outlet aperture.

A grille for ventilation assembly is disclosed comprising a top plate having an outermost edge, wherein the top plate defines an outlet aperture; a bottom plate; a pair of guide vanes extending between the top plate and the bottom plate and defining a flow path; and an outer acoustic body located in the flow path and an inner acoustic body located in the flow path. The outer acoustic body can be located adjacent to the outermost edge of the top plate. The inner acoustic body can be located adjacent to the outlet aperture. The outer acoustic body and the inner acoustic body can define an acoustic feature. The acoustic feature can be a phononic crystal. At least one of the guide vanes can define a curvilinear path from the plate outermost edge to the outlet aperture. The acoustic bodies can extend between the top plate and the bottom plate. The acoustic bodies can extend from the top plate.

The foregoing and other features of the present disclosure will become more apparent upon reading of the following non-restrictive description of examples of implementation thereof, given by way of illustration only with reference to the accompanying drawings.

### BRIEF DESCRIPTION OF THE DRAWINGS

In the appended drawings, where like reference numerals denote like elements throughout and in where:

FIG. 1 is a perspective view of a non-restrictive illustrative embodiment of a ventilation assembly consistent with the present disclosure showing the ventilation assembly installed within a bathroom;

FIG. 2 is perspective view of the ventilation assembly of FIG. 1 in isolation;

FIG. 3 is an exploded perspective view of the ventilation assembly of FIG. 2;

FIG. 4 is a side elevation view of the grille of the ventilation assembly of FIG. 2;

FIG. 5 is a top plan view of the grille of the ventilation assembly of FIG. 4 showing a first plate of the grille comprises an outlet aperture;

FIG. 6 is cross-sectional view of the grille of the ventilation assembly of FIG. 5 taken along the line 6F-6;

FIG. 7 is a bottom plan view of the first plate of the grille of the ventilation assembly of FIG. 5 showing a plurality of acoustic bodies arranged annularly around the outlet aperture;

FIG. 8 is the perspective view of the bottom of the first plate of the grille of the ventilation assembly of FIG. 7 showing depth of the acoustic bodies;

FIG. 9 is a diagrammatic view indicating an arrangement of the acoustic bodies of FIG. 8;

FIG. 10 is a graphical representation of the sound attenuation benefits of the present disclosure

FIG. 11 is a perspective view of another illustrative embodiment of a ventilation assembly in accordance with the present disclosure including a partition plate included in a main housing and having a plurality of acoustic features formed thereon and that can be included in any of the ventilation assemblies described herein;

FIG. 12 is a perspective view of another embodiment of a partition plate included in a main housing and having a plurality of acoustic features formed thereon and that can be included in any of the ventilation assemblies described herein;

FIG. 13 is perspective view of a scroll housing including a plurality of acoustic features formed thereon and that can be included in any of the ventilation assemblies described herein;

FIG. 14 is an exploded assembly view of another exemplary embodiment of a ventilation assembly in accordance with the present disclosure;

FIG. 15 is a cross sectional view of a grille included in the ventilation assembly and taken along line 15-15 in FIG. 14;

FIG. 16 is a top view of the grille from FIGS. 14 and 15 showing that the grille is formed to include a plurality of acoustic features;

FIG. 17 is a perspective and cross sectional view of the grille of FIG. 16;

FIG. 18 is an exploded assembly view of another exemplary embodiment of a ventilation assembly in accordance with the present disclosure;

FIG. 19 is a cross sectional view of a grille included in the ventilation assembly and taken along line 19-19 in FIG. 18;

FIG. 20 is a top view of the grille from FIGS. 18 and 19 showing that the grille is formed to include a plurality of acoustic features;

FIG. 21 is a perspective and cross sectional view of the grille of FIG. 20;

FIG. 22 is an enlarged portion of the grille of FIG. 21;

FIG. 23 is a simplified schematic diagram of an expansion chamber, the effects of which are provided by the grilles of FIGS. 14-22;

FIG. 24 is a perspective view of another exemplary embodiment of a ventilation grille of a ventilation assembly in accordance with the present disclosure;

FIG. 25A is a bottom perspective view of a portion of the grille of FIG. 24;

FIG. 25B is a top perspective view of the grille portion of FIG. 25A;

FIG. 26A is a bottom plan view of the grille portion of FIG. 25A;

FIG. 26B is a top plan view of the grille portion of FIG. 25A;

FIG. 27 is a side plan view of the grille of FIG. 24; and

FIG. 28 is a cross-sectional view of the grille of FIG. 24.

### DETAILED DESCRIPTION

Ventilation assemblies, such as ventilation fan assemblies, are often used to ventilate rooms (e.g. bathrooms and kitchens) in residential, commercial, and industrial structures. Bathroom ventilation fan assemblies are often installed in a cutout or cavity formed in a support member, such as bathroom ceiling or wall. Traditional ventilation fan assemblies may include grilles or other air inlet openings through which the fan can draw air from the room while obstructing direct view of the fan assembly.

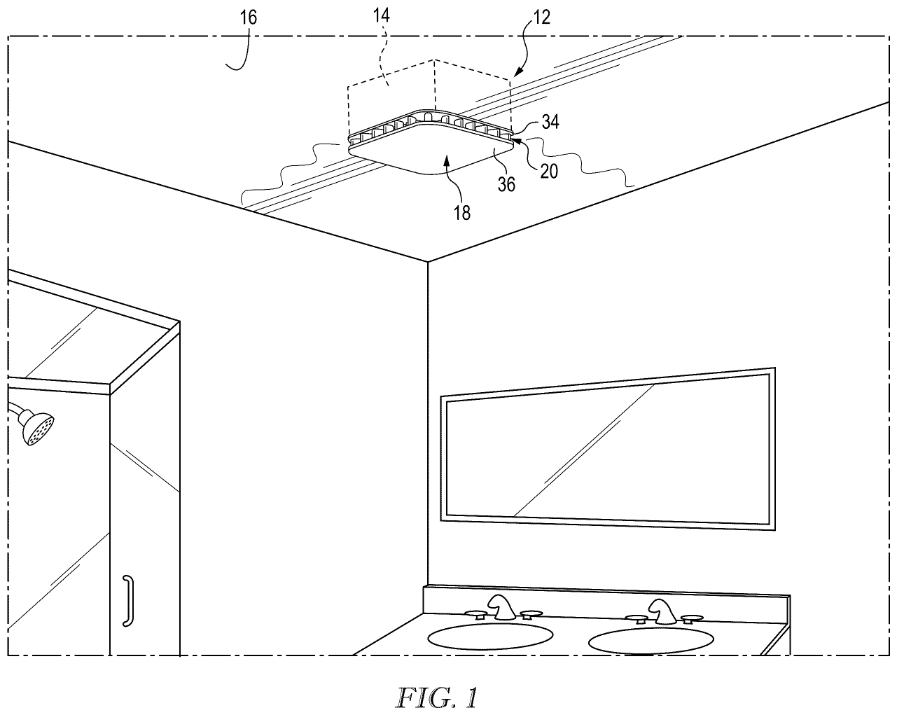

Referring to FIG. 1, an illustrative ventilation assembly 12 is shown installed within the ceiling of a bathroom. The ventilation assembly 12 includes a main housing 14 (as indicated in broken line in FIG. 1) located above the surface 16 of the ceiling and grille 18 for receiving air from the room, the grille 18 shown positioned in close proximity with the surface 16 of the ceiling and adjacent to an inlet 28 defined by the main housing 14. As discussed in additional detail below, the grille 18 include acoustic bodies 40 which can reduce the sound resulting from operation of the ventilation assembly 12.

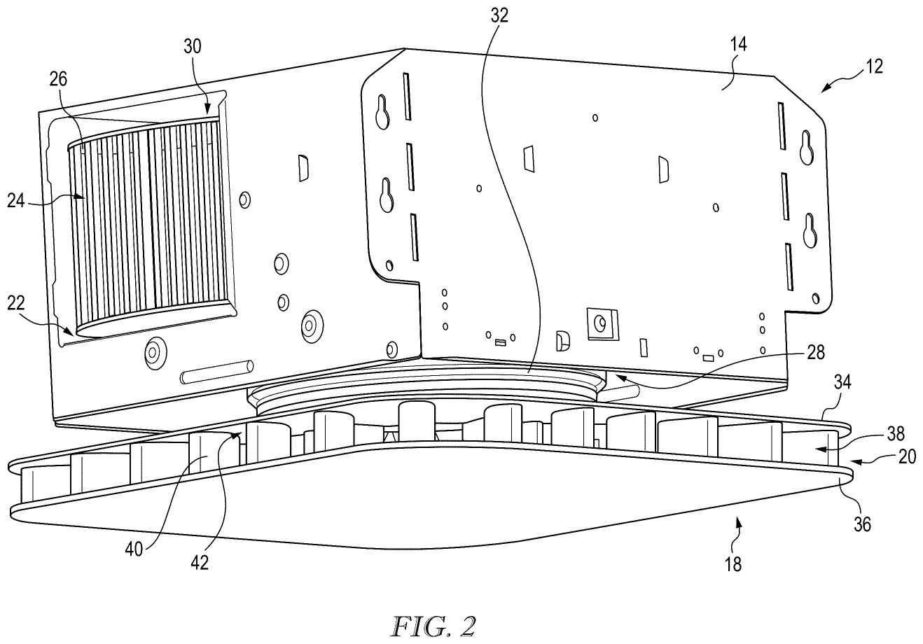

Referring now to FIG. 2, the main housing 14 defines an inner cavity 22 which houses a blower assembly 24. The blower assembly 24 includes a fan 26 operable by a motor to draw air from the adjacent room through the grille 18, through the inlet 28 (via the optional adaptor ring 32 discussed below) into the inner cavity 22 of the main housing 14 and out through an exhaust 30. The main housing 14 is illustratively shown as a square box, but in some embodiments may have any suitable arrangement including any suitable shape and/or size.

The grille 18 is illustratively arranged adjacent the inlet 28 of the main housing 14. The grille 18 is depicted as arranged in fluid communication with the inner cavity 22 via an optional flexible adaptor ring 32 to communicate air through from the room through the grille 18 and into the inner cavity 22 in an aerodynamically efficient manner. The main housing inlet 28 is depicted as an entire rectangular side of the main housing 14, but could alternatively be only an aperture the size and shape of the flexible adaptor ring 32. The grille 18 illustratively comprises a top plate 34 and bottom plate 36, and means for reducing sound 20 arranged between the plates 34, 36 to attenuate sound. As discussed in additional detail herein, as air flows through the grille 18, the means for reducing sound 20 can attenuate sound created by operation of the ventilation assembly 12.

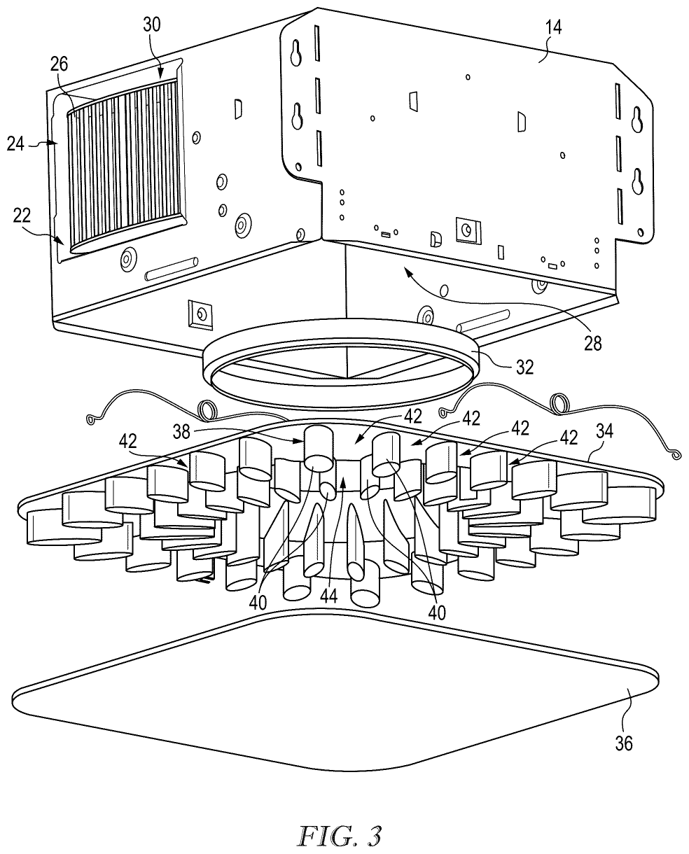

Referring to FIG. 3, the means for reducing sound 20 comprises a number of acoustic features 38 arranged to attenuate sound. Each acoustic feature 38 comprises a set of acoustic bodies 40, each set of acoustic bodies 40, which each acoustic feature 38, are collectively arranged to form a phononic crystal to attenuate sound, as discussed in additional detail herein. Adjacent acoustic features 38 are spaced apart from each other to define an air flow pathway 42 therebetween, which is bounded by the top and bottom plates 34, 36, where present. Both plates 34, 36 are not, however, required in all embodiments. Air is received from the room through the grille 18 at the outer perimeters of the top and bottom plates 34, 36, then travels through the airflow pathways 42 and then out of the grille 18 through an outlet aperture 44 defined in the top plate 24 and into the main housing 14. As discussed above, the air may optionally travel through a flexible adaptor ring 32.

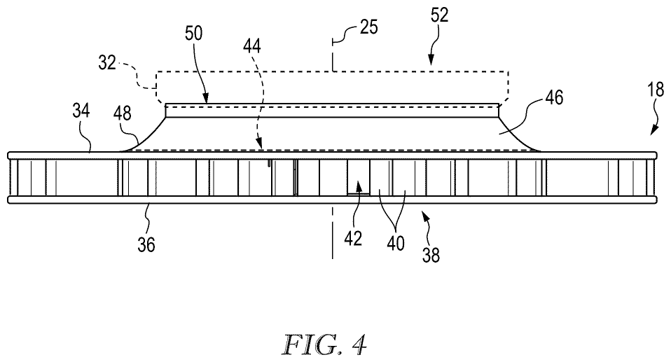

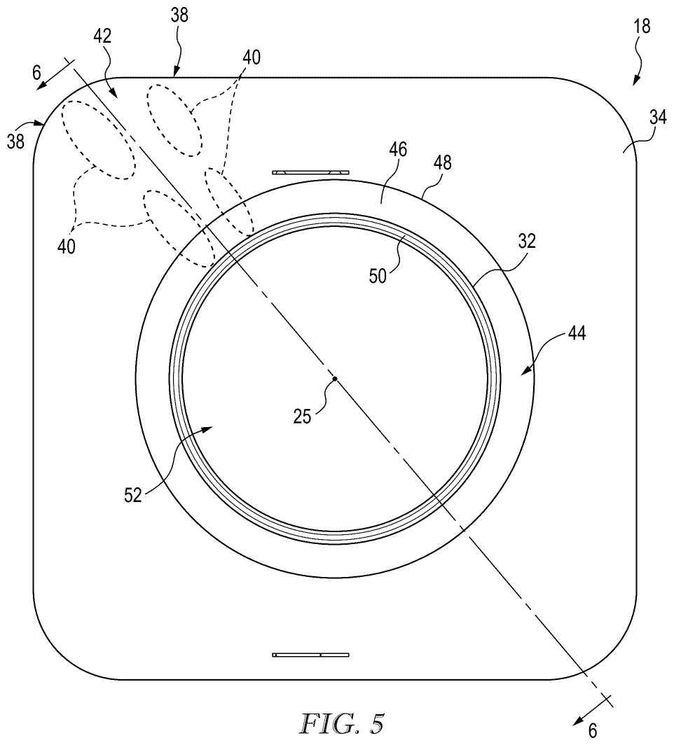

Referring now to FIGS. 4 and 5, the top plate 34 illustratively defines the outlet aperture 44. The grille 18 defines a collar 46 extending upwardly from the top plate 34 for connection with the adaptor ring 32 to fluidly communicate the outlet aperture 44 with the inner cavity 22 of the main housing 14. The collar 46 is illustratively formed hollow to communicate with the outlet aperture 44 on a first end 48 and with the adaptor ring 32 on the opposite, second end 50. The collar 46 and the adaptor ring 32 collectively define a flow passage 52 communicating between the outlet aperture 44 and the adaptor ring 32.

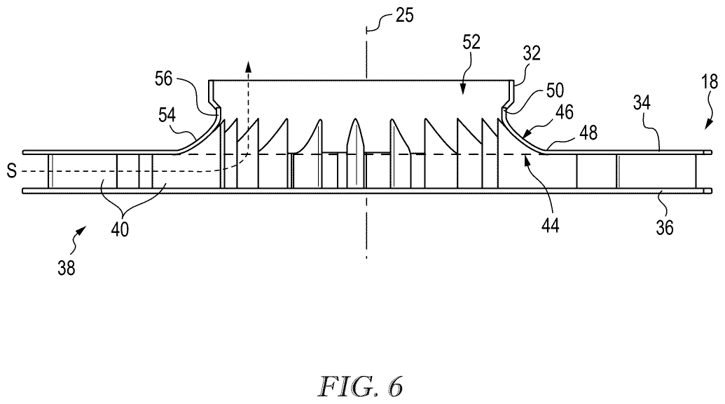

In FIG. 6, the collar 46 is illustratively formed to define a torus section 54 extending from the plate 34 at the collar first end 48 and a mating section 56 extending from the torus section 54 to define the second end 50 for engagement with the adaptor ring 32. The adaptor ring 32 can be separate from the collar 46 and secured thereto by any known means (e.g. force fit, adhesive, sonic weld, etc.) or the adaptor ring 32 can be integral with the collar 46.

The collar 46 defines a manifold transition section between the grille 18 and the ventilation assembly main housing 14 to provide smooth aerodynamic transition there between. In particular, the collar 46 extends from the top plate 34 toward the fan 26 to direct fluid flow toward the fan 46 and preventing fluid flow from greater access to the main housing inner cavity 22 which can redirect the fluid flow and/or create unwanted turbulence in the fluid flow, thereby lowering the efficiency of the ventilation assembly 12. Stated differently, the collar 46 directs the fluid flow from the top plate 34 toward the fan 24 in an aerodynamically efficient manner. The collar 46 can be configured so that the collar second end 50 approximately reaches the fan 24 upon installation. Alternatively, the collar second end can be spaced from the fan 24. The optional adaptor ring 32 can provide additional length to the collar 46 to lengthen the control of the fluid flow into the main housing 14 and toward the fan 24. In some embodiments, the collar second end 50 and/or the optional adaptor ring 32 can be sized to approximate the inlet of the fan 24 to deliver the fluid flow from the top plate 34 to the fan 24.

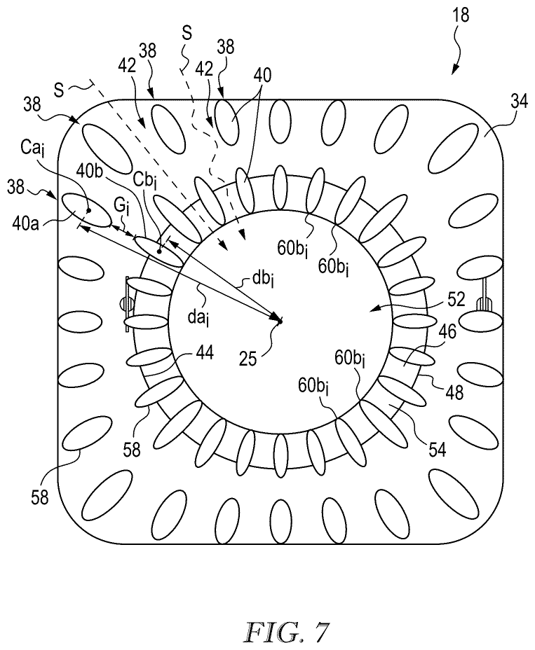

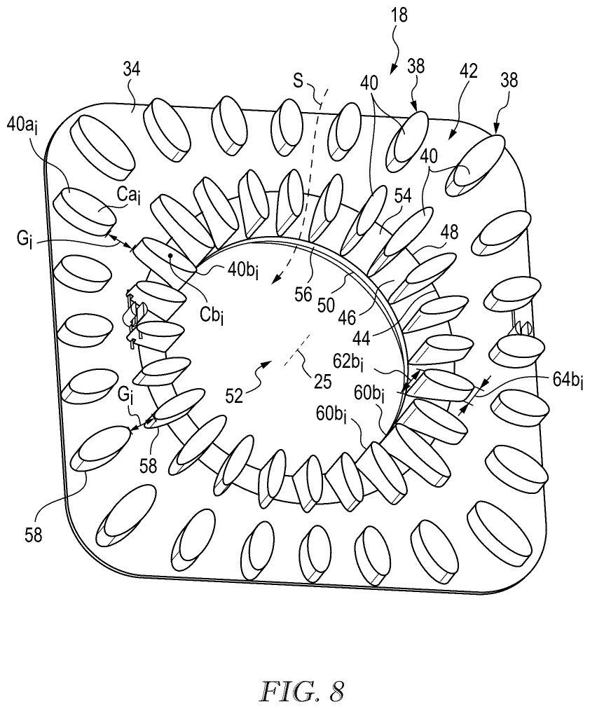

FIGS. 7 and 8 depict an exemplary arrangement of the acoustic features 38 illustratively includes a pair of acoustic bodies 40, including outer acoustic body 40a and inner acoustic body 40b, although in some embodiments, the acoustic features 38 may include any suitable number of acoustic bodies 40 in forming phononic crystals. For example, an acoustic feature 38 may include three, four or more radially spaced acoustic bodies 40. Thus, the terms “inner” and “outer” when applied to acoustic bodies 40 are relative and are not to be interpreted as “innermost” and “outermost” unless context dictates otherwise. The outer acoustic bodies 40a are arranged annularly around the outlet aperture 44, and the inner acoustic bodies 40b are also arranged annularly around the outlet aperture 44, with the inner and outer acoustic bodies 40b,a aligned along the same radius. Each outer acoustic body 40a is arranged at a radial distance daᵢ (e.g., da₁₋ₙ for example of 1 through n acoustic features 38) between its centroid Caᵢ and a center axis 25 of the outlet aperture 44 that is greater than the radial distance dbᵢ (e.g., db₁₋ₙ for example of 1 through n acoustic features 38) between the centroid Cbᵢ of the corresponding inner acoustic body 40b of the same acoustic feature 38 and the center axis 25.

Each acoustic body 40 includes an outer perimeter 58 defining smooth aerodynamic shape, illustrated as approximating an ellipse, although in some embodiments, any suitable shape may be applied to each acoustic body 40. The inner and outer acoustic bodies 40a, 40b of each acoustic feature 38 are radially spaced apart from each other to define a gap Gᵢ between their outer perimeters 58. Each acoustic body 40 is arranged to extend longitudinally along the radial direction relative to the outlet aperture 44.

In the example embodiment of FIG. 7, the most radially inward portion 60bᵢ of each inner acoustic body 40b is coincident with the collar 46, and namely with in the mating section 56 of the collar 46. Alternatively, the most radially inward portion 60bᵢ may be spaced from the collar and the outlet aperture 44. In other alternative embodiments in which the grille 18 has no collar 46, the inner acoustic bodies 40b can be located on the top plate 34 and the most radially inward portion 60bᵢ can be coincident with the outlet aperture 44. In the embodiment depicted in FIG. 8, the most radially inward portion 60bᵢ of each inner acoustic body 40b defines a height 62bᵢ extending for connection with the inner surface of the collar 46, the height 62bᵢ being larger than a height 64bᵢ of the most radially outer portion of the inner acoustic body 40b due to the inwardly curved section 54 of collar 46. In alternative embodiments, the acoustic bodies 40 are of uniform height and are placed on a flat portion of the plates 34, 36. In the illustrative embodiment, the acoustic bodies 40 are formed as extruded-2-dimensional shapes having uniform dimensions of their outer perimeter 58 along their height, but in some embodiments, each acoustic body 40 may have curvature along its height.

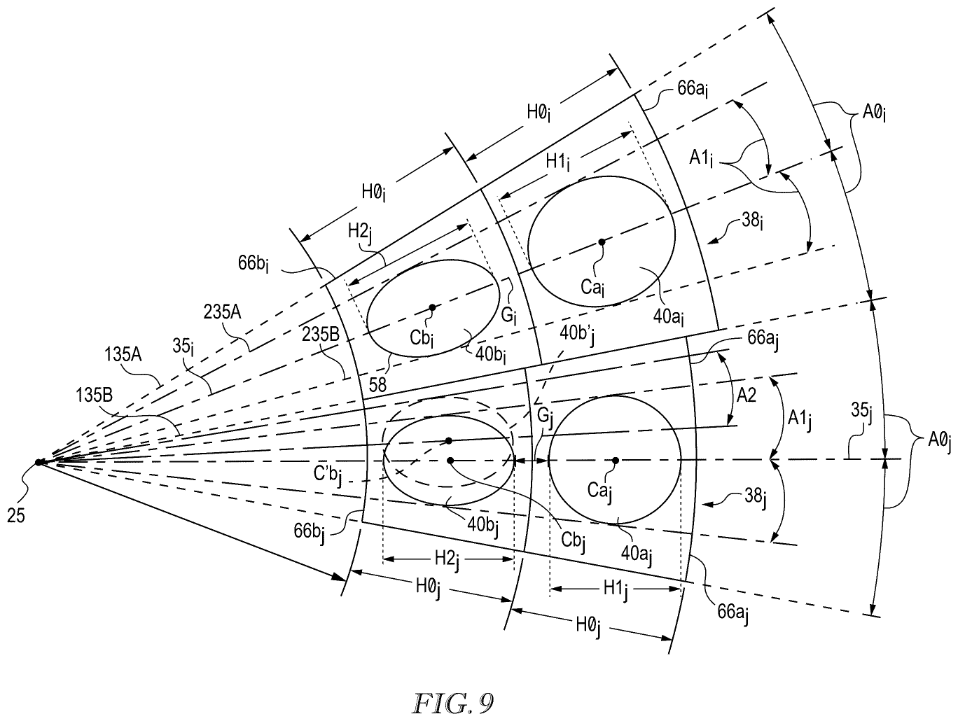

Referring now to FIG. 9, arrangements of the acoustic bodies 40 of individual acoustic features 38, and of the collective acoustic features 38 are discussed in terms of exemplary acoustic features 38; and 38j arranged adjacent one another. In particularly, each acoustic body 40 is configured according to a corresponding elementary cell 66x_{i,j} (e.g., 66a₁₋ₙ, 66b₁₋ₙ). Each elementary cell 66 can assist in defining the dimensions of the corresponding acoustic body 40, the relative positions between inner and outer acoustic bodies 40a, 40b of the same acoustic feature 38, and/or the open space between adjacent acoustic bodies 40, as discussed herein.

For example, in the annular arrangements of the acoustic bodies 40 of the illustrative embodiments, the centroids Ca, Cb of the acoustic bodies 40a, 40b are arranged co-linear on their corresponding center lines 35_{i,j}. The lateral boundaries, and thus the width, of the elementary cells 66 are defined by the lines 135A, 135B, which are themselves defined at an angle A0 relative to their corresponding center lines 35_{i,j}. The dimensions of the acoustic bodies 40 can be defined in terms of the parameters of their elementary cells 66. For example, the width of the acoustic bodies 40a, 40b of each acoustic feature 38 are defined such that the outer perimeter 58 of the outer and inner acoustic bodies 40a, 40b are respectively tangential to lines 235A, 235Bᵢ that are defined at an angle A1 relative to their corresponding center lines 35_{i,j}. An angular ratio of the acoustic body 40 and its elementary cell 66 can be defined as A1/A0.

The longitudinal (radial) thickness of each cell 66 is defined as H0. The longitudinal (radial) thickness of each acoustic body 40 is indicated as H1. A thickness ratio of the acoustic body 40 and its elementary cell 66 can be defined as H1/H0.

The thickness H0 of the elementary cells 66a, 66b is illustratively defined to fix the center of the frequency bandgap for attenuation, according to the relationship k*H0=π, where k is the angular wavenumber in the surrounding fluid (e.g., air). The center of the frequency band can be defined accordingly to the relationship

$$f = \frac{c}{2 * H 0} ,$$

where c is the speed of sound in the surrounding fluid (e.g., air). The width of the frequency band gap and the sound attenuation level are linked to the filling ratio r of the acoustic body 40 to its elementary cell 66, according to the relationship

$$r = \frac{S c}{S e} ,$$

where S_{c} is 2-dimensional area defined by the perimeter 58 of the acoustic body 40, and Sₑ is the 2-dimensional area defined by the elementary cell 66. The filing ratio r is related to each of the angular ratio A1/A0 and the thickness ratio H1/H0.

The acoustic bodies 40 can be made of any known material and provides the best performance with made of materials of high acoustical impedance. The acoustic bodies 40 may be solid or hollow. In one example, hollow acoustic bodies 40 may be used as Helmholtz resonators to dampen some frequencies. A solid acoustic body 40 could comprise an outer shell filled with any material. In one example, an acoustic body 40 could comprise a shell filled with a sound reducing material. One or more of the acoustic bodies 40 may be integrally formed as part of the upper plate 34 or the lower plate 36 or both 34, 36. Alternatively, one or more of the acoustic bodies 40 may be formed separate from the upper plate 34 and the lower plate 36 and affixed to one of the upper plate 34 or the lower plate 36 or both 34, 36 in any known manner consistent with this disclosure (e.g. adhesive, sonic welding, etc.). The acoustic bodies 40 may be manufactured by any known process (e.g. injection molding).

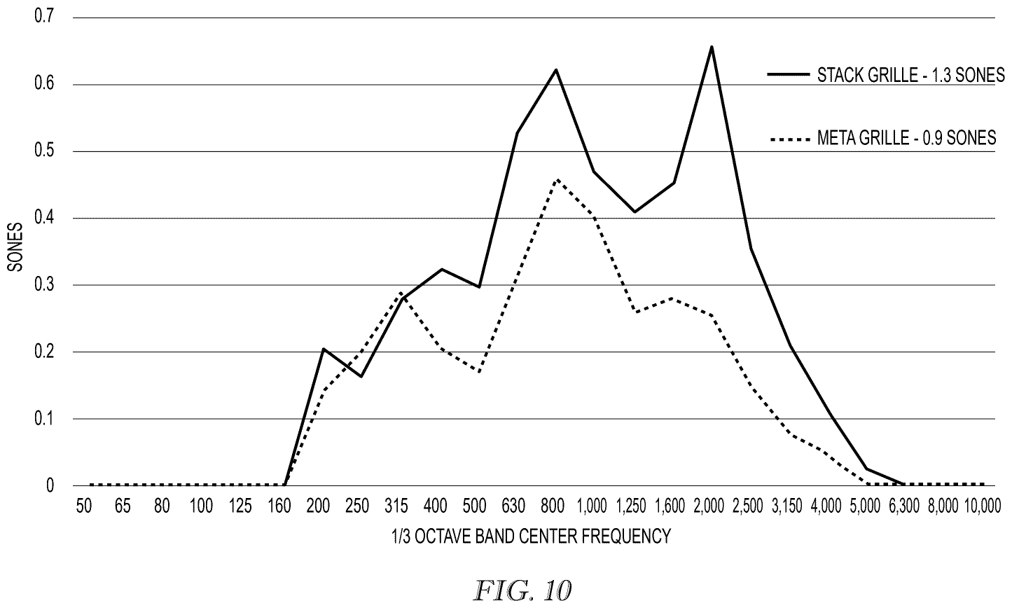

Based on common conditions for bathroom ventilation applications, exemplary ranges of values can be determined for defining the arrangements of the acoustic features 38. For example, exemplary values can be determined for a frequency band of about 200 to about 4000 Hz defined by a ⅓ octave band center frequency as shown in FIG. 10. Exemplary values for such given conditions can include angular ratios within the range of about 0.3 to about 0.5 and/or thickness ratios within the range of about 0.6 to about 0.8. Exemplary values for the angle of A0 can include A0 within the range of about 5 degrees to about 10 degrees from centerline 35.

Returning to FIG. 9, with reference to the acoustic feature 38ⱼ, the inner acoustic bodies 40b are illustratively centered on their corresponding center line 35 together with the outer acoustic body 40a. However, in some embodiments, the inner acoustic bodies 40b may be arranged off-center from their corresponding center line 35_{i,j} such that their centroid Cis spaced apart from the corresponding center line 35_{i,j}. For example, as shown in FIG. 9, the alternative inner acoustic body 40b′ⱼ is arranged slightly off-center from the center line 35j, such that the centroid Ch′ⱼ is arranged on a line 45ⱼ which defines an angle A2ⱼ from center line 35ⱼ. Exemplary values for the angle A2 for given conditions can include A2 being no greater than about 1/10th of A0.

The discussion of arrangements of the acoustic bodies 40 applies generically to each acoustic body 40 of a given acoustic feature 38, yet the acoustic features 38 may be arranged differently from other acoustic features 38 according to the concepts discussed above, for example, according to the particular conditions, physical parameters (configuration of moving parts of the ventilation assembly, geometries of the grille, etc.) and/or other internal and/or external factors. Adjacent acoustic features, such as acoustic features 38_{i,j} may differ in their arrangements but with preferred relationships there between, for example, to maintain overall circularity for the annular arrangements of the illustrative embodiments. Exemplary relationships can include variation of angles A0ᵢ and A0ⱼ of adjacent acoustic fixtures 38_{i,j} relative to each other within the range of about 1/1.2 to about 1.2. Exemplary relationships can include variation in the thicknesses H0ᵢ and H0ⱼ of adjacent acoustic fixtures 38_{i,j} relative to each other within the range of about 1/1.2 to about 1.2.

Referring to FIG. 10, a comparison is shown of the sound levels of an example ventilation assembly operating with a Stack Grille with the sound levels of the example ventilation assembly operating with the grille 18 according to the present disclosure (indicated as Meta Grille). Within the target ⅓ octaves (⅓ octave center band frequencies from 160 Hz to 6300 Hz) the level of sones from the Meta Grille were significantly reduced compared to the Stack Grille. A grille according to the description herein, including the example Meta Grille, with or without structural alterations within this disclosure, would reduce the level of sones in other frequency bands as well.

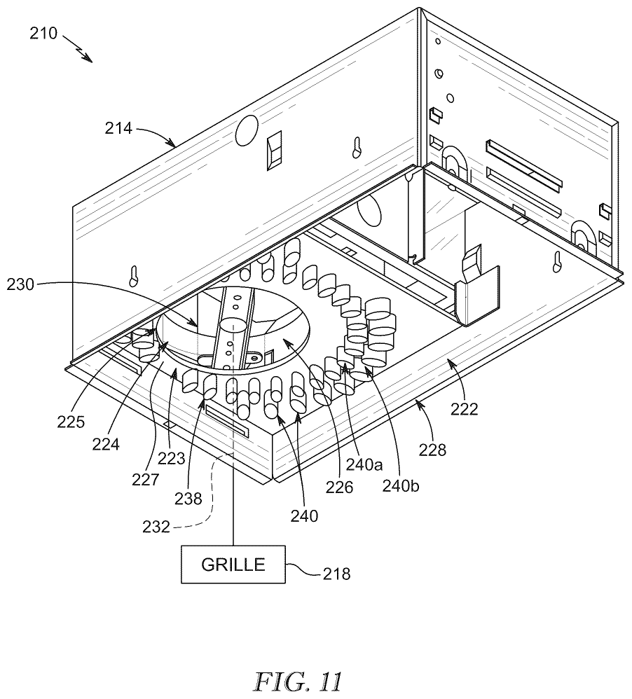

Referring to FIG. 11, a second embodiment of a ventilation assembly 210 including a main housing 214 defining an interior cavity 222, a grille 218 coupled to the main housing 214 to cover an opening in a ceiling, for example, and a partition plate 223 located within the interior cavity 222. As described below, the partition plate 223 includes acoustic bodies 240 which attenuate noise during operation of the ventilation assembly 210.

The interior cavity 222 houses a blower assembly 224. The blower assembly 24 includes a fan 226 operable by a motor to draw air from the adjacent room through the grille 218, through a main housing inlet 228 (via the optional adaptor ring 32 discussed below) into the inner cavity 222 of the main housing 214 and out through an exhaust 230 defined in the main housing inlet 228. The main housing 214 is illustratively shown as a square box, but in some embodiments may have any suitable arrangement including any suitable shape and/or size.

The grille 218 is illustratively arranged adjacent the inlet 228 of the main housing 214. The grille 218 is depicted as arranged in fluid communication with the interior cavity 222. An optional flexible adaptor ring, such as adaptor ring 32, may be utilized to communicate air through from the room through the grille 218 and into the interior cavity 222 to the acoustic bodies 240 in an aerodynamically efficient manner. The main housing inlet 228 is depicted as an entire rectangular side of the main housing 214, but could alternatively be only an aperture the size and shape of the flexible adaptor ring 32. The grille 218 may comprise other structures that direct air toward an outer perimeter of the acoustic bodies 240 so that the air flows radially through the acoustic bodies 240 to the blower assembly 224.

The partition plate 223 divides the interior cavity 222 into multiple sub-regions to separate various components such as the blower assembly 224 and other electrical systems or modules in the interior cavity 222. The partition plate 223 is spaced apart vertically from the grille 218 and defines a partition plate inlet 225 that opens toward the blower assembly 224. The partition plate inlet 225 is circular about a central axis 232. Each of the acoustic bodies 240 is optionally formed integrally with the partition plate 223 and extend from a bottom surface 227 of the partition plate 223 to extend downwardly toward the grille 218 and away from the blower assembly 224.

The acoustic bodies 240 are arranged around the central axis 232 and form an exemplary arrangement of the acoustic features 238 that illustratively includes a pair of acoustic bodies 240, including an inner acoustic body 240a and an outer acoustic body 240b, although in some embodiments, the acoustic features 238 may include any suitable number of acoustic bodies 240 in forming phononic crystals. For example, an acoustic feature 238 may include only one or three, four or more radially spaced acoustic bodies 240. Thus, the terms “inner” and “outer” when applied to acoustic bodies 240 are relative and are not to be interpreted as “innermost” and “outermost” unless context dictates otherwise.

The inner and outer acoustic bodies 240a, 240b are staggered circumferentially about the central axis 232 in the illustrative embodiment although in some embodiments the acoustic bodies 240a, 240b may be circumferentially aligned. Thus, each outer acoustic body 240b is arranged approximately between two neighboring inner acoustic bodies 240a and is spaced radially outward from the inner acoustic bodies 240a. Each of the acoustic bodies 240 has an elliptical shape with a centerline that extends through the central axis 232, however, as described in other embodiments herein, one or more of the acoustic bodies 240 can have other suitable shapes including a circular shape.

As shown in FIG. 11, the inner and outer acoustic bodies 240a, 240b need not extend all the way around the central axis 232 of the inlet 225 if space does not permit. Thus, some circumferential positions around the central axis 232 may have only one inner or outer acoustic body 240a, 240b, or no acoustic bodies 240. In the illustrative embodiment, greater than 50% of the circumference of the inlet 225 has both inner and outer acoustic bodies 240a, 240b and less than 10% of the circumference has no acoustic bodies 240.

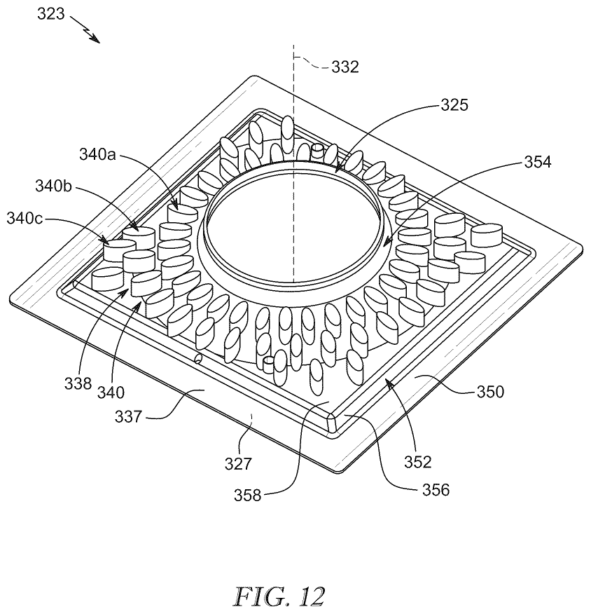

Another embodiment of a partition 323 that can be used in any of the ventilation assemblies described herein is shown in FIG. 12. The partition plate 323 is substantially similar to partition plate 223 except that a plurality of acoustic bodies 340 are formed on a top surface 337 of the partition plate 323 instead of a bottom surface 327.

The partition plate 323 is configured to divide an interior cavity of a main housing (i.e. main housing 214) into multiple sub-regions to separate various components such as the blower assembly 224 and other electrical systems or modules in the interior cavity 222. When fully installed on a main housing, the partition plate 323 is spaced apart vertically from a grille (i.e. the grille 218) and defines a partition plate inlet 325. The inlet 325 is circular about a central axis 332. Each of the acoustic bodies 340 is optionally formed integrally with the partition plate 323. When the partition plate 323 is fully installed in the housing 314, each of the acoustic bodies 340 extend upwardly away from the grille and toward the blower assembly.

The acoustic bodies 340 are arranged around the central axis 332 and form an exemplary arrangement of the acoustic features 338 that illustratively includes a trio of acoustic bodies 340, including an inner acoustic body 340a and a middle acoustic body 340b, and an outer acoustic body 340c, although in some embodiments, the acoustic features 338 may include any suitable number of acoustic bodies 340 in forming phononic crystals. For example, an acoustic feature 338 may include one, two, four, or more radially spaced acoustic bodies 340. Thus, the terms “inner” and “outer” when applied to acoustic bodies 340 are relative and are not to be interpreted as “innermost” and “outermost” unless context dictates otherwise.

Some of the acoustic bodies 340a, 340b, 340c are staggered circumferentially about the central axis 332 in the illustrative embodiment. For example, each middle acoustic body 340b is arranged approximately between two neighboring inner acoustic bodies 340a and each outer acoustic body 340c is arranged approximately between two neighboring middle acoustic bodies 340b. Each of the acoustic bodies 340 has an elliptical shape with a centerline that extends through the central axis 332, however, as described in other embodiments herein, one or more of the acoustic bodies 340 can have other suitable shapes including a circular shape.

As shown in FIG. 12, the acoustic bodies 340a, 340b, 340c may not extend all the way around the central axis 332 of the inlet 325. Thus, some circumferential positions around the central axis 332 may have only an inner acoustic body 340a, or only an inner and a middle acoustic body 340a, 340b. In the illustrative embodiment, greater than 50% of the circumference of the inlet 325 has only inner and middle acoustic bodies 340a, 340b and less than 10% of the circumference has inner, middle, and outer acoustic bodies 340a, 340b, 340c.

The partition plate 323 includes a peripheral rim 350, a central pane 352 coupled to an inner edge of the peripheral rim 350, and a collar 354 coupled to an inner edge of the central pane 352 as shown in FIG. 12. The peripheral rim 350 is square-shaped in the illustrative embodiment and is configured to attach to portions of the main housing to support the partition plate 323 relative to the blower assembly. In other embodiments, other shapes including rectangular, circular, triangular, or other suitable polygonal shapes may also be used. The central pane 352 is similarly shaped to the peripheral rim 350 and includes a shoulder 356 coupled to the peripheral rim 350 and a panel 358 interconnecting the shoulder 356 and the collar 354. The collar 354 extends upwardly away from the panel 358 in the same direction as the acoustic bodies 340. Each of the acoustic bodies 340 is coupled to the panel 358 and/or the shoulder 356 and is configured to attenuate sound by interacting with air flowing outwardly away from the central axis 332.

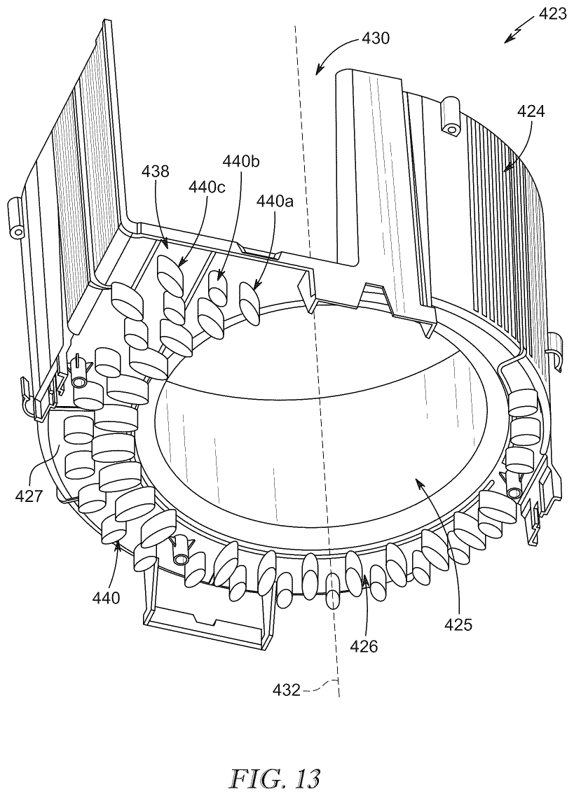

Referring to FIG. 13, some illustrative ventilation assemblies may not have a partition plate such as plates 223, 323. Instead, any of the ventilation assemblies described herein can have a scroll housing 423 which is arranged within a main housing (i.e. main housing 14, 214) and which contains a fan (i.e. fan 26, 226). The scroll housing 423 includes a side wall 424 and a bottom wall 426. The bottom wall 426 defines an inlet 425 while the side wall defines an outlet 430. During operation in which the fan rotates about a central axis 432 of the inlet 425 within the scroll housing 423, air is drawn upwardly through the inlet 425 and is released through the outlet 430.

The scroll housing 423 further includes a plurality of acoustic bodies 440 extending from a bottom surface 427 of the bottom wall 426 as shown in FIG. 13. The plurality of acoustic bodies 440 extend downwardly away from the bottom wall 426 and the side wall 424. The acoustic bodies 440 are arranged around the central axis 432 and form an exemplary arrangement of the acoustic features 438 that illustratively includes a trio of acoustic bodies 440, including an inner acoustic body 440a, a middle acoustic body 440b, and an outer acoustic body 440c, although in some embodiments, the acoustic features 438 may include any suitable number of acoustic bodies 440 in forming phononic crystals. For example, an acoustic feature 438 may include one, two, four, or more radially spaced acoustic bodies 440. Thus, the terms “inner” and “outer” when applied to acoustic bodies 340 are relative and are not to be interpreted as “innermost” and “outermost” unless context dictates otherwise.

Some of the acoustic bodies 440a, 440b, 440c are staggered circumferentially about the central axis 432 in the illustrative embodiment. For example, each middle acoustic body 440b is arranged approximately between two neighboring inner acoustic bodies 440a and each outer acoustic body 440c is arranged approximately between two neighboring middle acoustic bodies 440b. Each of the acoustic bodies 440 has an elliptical shape with a centerline that extends through the central axis 432, however, as described in other embodiments herein, one or more of the acoustic bodies 440 can have other suitable shapes including a circular shape.

As shown in FIG. 13, the acoustic bodies 440a, 440b, 440c may not extend all the way around the central axis 432 of the inlet 425. Thus, some circumferential positions around the central axis 432 may have only an inner acoustic body 440a, or only an inner and a middle acoustic body 440a, 440b. In the illustrative embodiment, greater than 50% of the circumference of the inlet 425 has only inner and middle acoustic bodies 440a, 440b and less than 10% of the circumference has inner, middle, and outer acoustic bodies 440a, 440b, 440c.

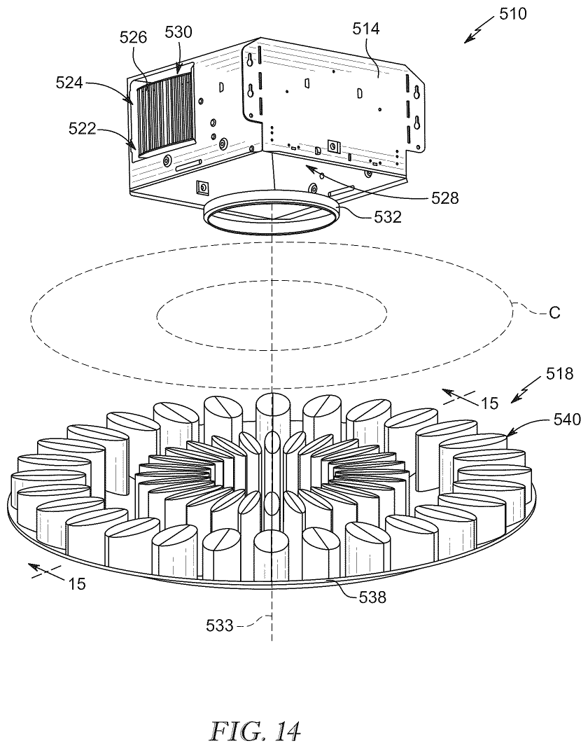

Another embodiment of a ventilation assembly 510 is shown in FIGS. 14-17. The ventilation assembly 510 includes a main housing 514 defining an interior cavity 522 and a grille 518 coupled to the main housing 514 to cover an opening in a ceiling C, for example. As described below, the grille 518 includes acoustic bodies 540 which attenuate noise during operation of the ventilation assembly 510.

The interior cavity 522 houses a blower assembly 524. The blower assembly 524 includes a fan 526 operable by a motor to draw air from the adjacent room through the grille 518, through an inlet 528 (via the optional adaptor ring 532 discussed below) into the inner cavity 522 of the main housing 514 and out through an exhaust 530. The main housing 514 is illustratively shown as a square box, but in some embodiments may have any suitable arrangement including any suitable shape and/or size.

The grille 518 is illustratively arranged adjacent the inlet 528 of the main housing 514. The grille 518 is depicted as arranged in fluid communication with the interior cavity 522. An optional flexible adaptor ring 532 may be utilized to communicate air through from the grille 518 and into the interior cavity 522 in an aerodynamically efficient manner. The main housing inlet 528 is depicted as an entire rectangular side of the main housing 514, but could alternatively be only an aperture the size and shape of the flexible adaptor ring 532.

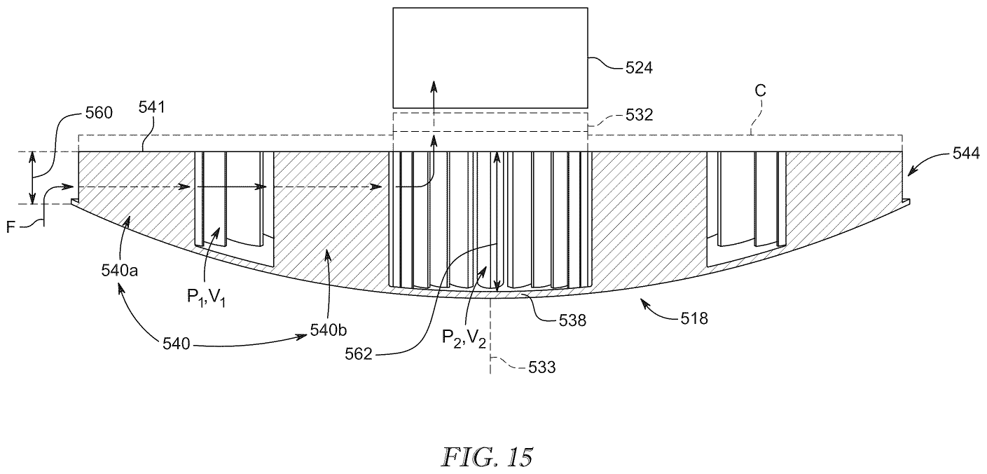

The grille 518 includes a dome-shaped panel 538 and the plurality of acoustic bodies 540 extend from an upper surface 537 of the dome-shaped panel 538 as shown in FIGS. 14 and 15. The dome-shaped panel 538 is imperforate such that no air can flow therethrough. Each of the acoustic bodies 540 is optionally formed integrally with the dome-shaped panel 538 and are extend upwardly toward the main housing 514 and toward the blower assembly 524. When the ventilation assembly 510 is fully installed, the plurality of acoustic bodies 540 may optionally contact the ceiling C to block airflow above the acoustic bodies 540 and so that airflow occurs only between the acoustic bodies radially inward toward a central axis 533 of the grille 518.

The acoustic bodies 540 are spaces apart circumferentially about the central axis 533 from one another and form an exemplary arrangement of the acoustic features 544 that illustratively includes a pair of acoustic bodies 540, including an inner acoustic body 540a and an outer acoustic body 540b, although in some embodiments, the acoustic features 544 may include any suitable number of acoustic bodies 540 in forming phononic crystals. For example, an acoustic feature 544 may include only one or three, four or more radially spaced acoustic bodies 540. Thus, the terms “inner” and “outer” when applied to acoustic bodies 540 are relative and are not to be interpreted as “innermost” and “outermost” unless context dictates otherwise.

The inner and outer acoustic bodies 540a, 540b are aligned circumferentially about the central axis 533 and spaced radially from the central axis 533 in the illustrative embodiment. Each of the acoustic bodies 540 has an elliptical shape with a centerline that extends through the central axis 533, however, as described in other embodiments herein, one or more of the acoustic bodies 540 can have other suitable shapes including a circular shape.

Referring to FIG. 16, the outer acoustic bodies 540b have a larger cross sectional area compared to the inner acoustic bodies 540a, however, a radial length of each acoustic body 540 may be substantially or approximately the same (i.e. within 5% of each other). Additionally, circumferential spacing between the outer acoustic bodies 540b is greater than circumferential spacing between the inner acoustic bodies 540a. The outer acoustic bodies 540b are spaced slightly inward from an outer edge 539 of the dome-shaped panel 538.

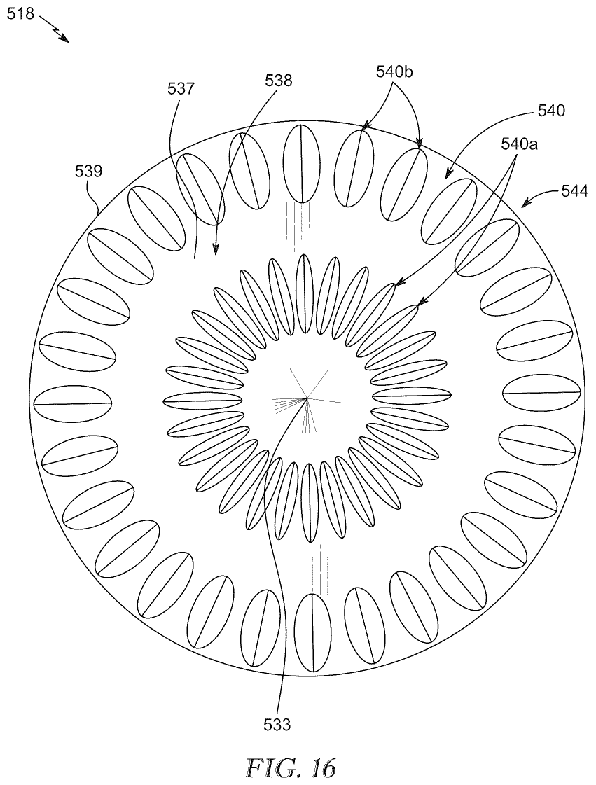

Referring to FIG. 17, a height of each of the acoustic bodies 540 varies as the acoustic bodies 540 extend radially inward toward the central axis 533 due to the dome-shaped panel 538. Illustratively, the outer acoustic bodies 540b have a first height 570 at a radially outer end thereof and a second height 572 at a radially inner end thereof. Likewise, the inner acoustic bodies 540a have a third height 574 at a radially outer end thereof and a fourth height 576 at a radially inner end thereof. The heights 570, 572, 574, 576 progressively get larger due to the shape of the dome shaped panel 538.

The structure of the grille 518 and ductwork (i.e. adaptor 532 or other structure of main housing 514 leading to the fan 526) leading to the fan 526 provides an expansion chamber effect that reduces sound produced by the ventilation assembly 510 during operation. In particular, the shape of the dome-shaped panel 538 slopes downwardly toward the central axis 533 to provide the upper surface 537 with a concave shape relative to the ductwork 532. The concave upper surface 537 and the ceiling C cooperate to define a flowpath that leads to the ductwork for an airflow F to flow vertically therebetween as shown in FIG. 15.

The upper surface 537 is spaced a first distance 560 from an upper end 541 of each of the acoustic bodies 540 and the ceiling C at an outer peripheral edge 539 of the dome-shaped panel 538. The upper surface 537 is spaced a second distance 562 from the upper end 541 and the ceiling C at the central axis 533. The second distance 562 is greater than the first distance 560 to provide a greater volumetric space between the dome-shaped panel 538 and the ceiling C the closer to the central axis 533. This volumetric change provided by the dome-shaped panel 538 causes the airflow to decrease in pressure from a first pressure P₁ closer to the outer edge 539 to a second pressure P₂ closer to the central axis 533. This volumetric change provided by the dome-shaped panel 538 also causes the airflow to decrease in velocity from a first velocity V₁ closer to the outer edge 539 to a second velocity V₂ closer to the central axis 533. These changes in pressure and/or velocity contribute to decreasing sound produced by the ventilation assembly 510.

It should be noted that while the dome-shaped panel 538 is used in the illustrative embodiment, in other embodiments, the expansion chamber effect may be produced by other panels having other shapes. Such shapes may include a conical structure, for example. Additionally, in other embodiments, the expansion chamber effect may occur as a result of increasing distance between the panel 538 from the outer edge 539 to the central axis 533 followed by a decrease in volumetric area in the ductwork leading to the fan 526.

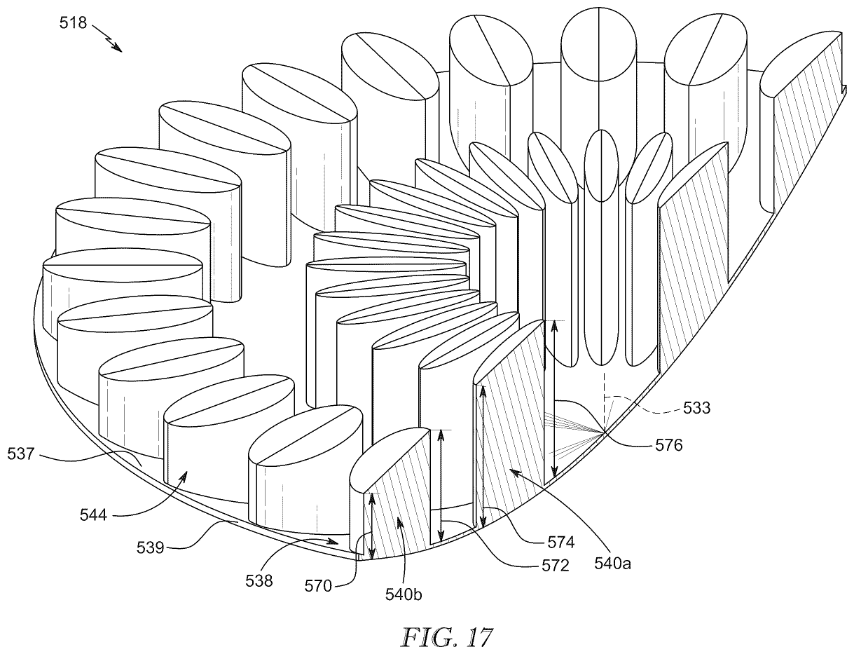

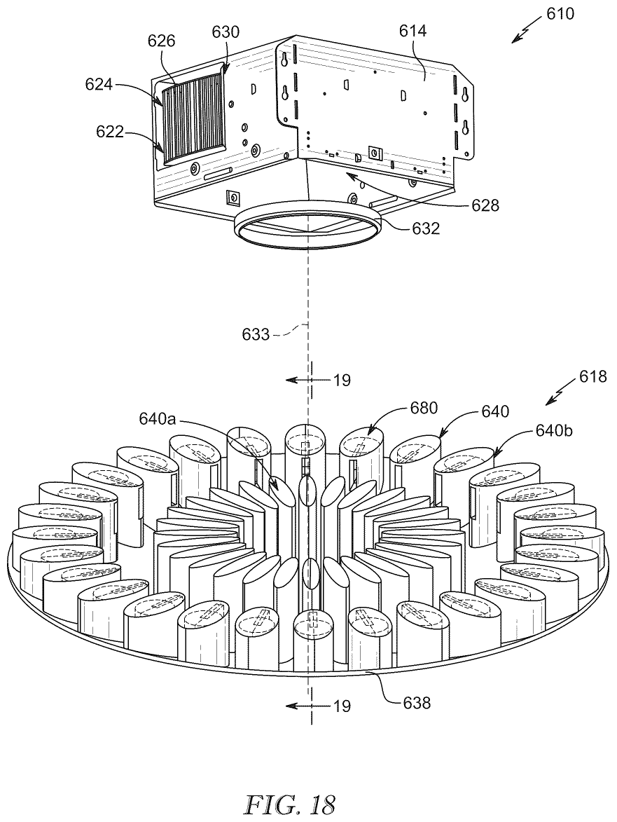

Another embodiment of a ventilation assembly 610 is shown in FIGS. 18-22. The ventilation assembly 610 includes a main housing 614 defining an interior cavity 622 and a grille 618 coupled to the main housing 614 to cover an opening in a ceiling C, for example. As described below, the grille 618 includes acoustic bodies 640 which attenuate noise during operation of the ventilation assembly 610.

The interior cavity 622 houses a blower assembly 624. The blower assembly 624 includes a fan 626 operable by a motor to draw air from the adjacent room through the grille 618, through an inlet 628 (via the optional adaptor ring 632 or ductwork discussed below) into the inner cavity 622 of the main housing 614 and out through an exhaust 630. The main housing 614 is illustratively shown as a square box, but in some embodiments may have any suitable arrangement including any suitable shape and/or size.

The grille 618 is illustratively arranged adjacent the inlet 628 of the main housing 614. The grille 618 is depicted as arranged in fluid communication with the interior cavity 622. An optional flexible adaptor ring 632 may be utilized to communicate air through from the room through the grille 618 and into the interior cavity 622 to the acoustic bodies 640 in an aerodynamically efficient manner. The main housing inlet 628 is depicted as an entire rectangular side of the main housing 614, but could alternatively be only an aperture the size and shape of the flexible adaptor ring 632.

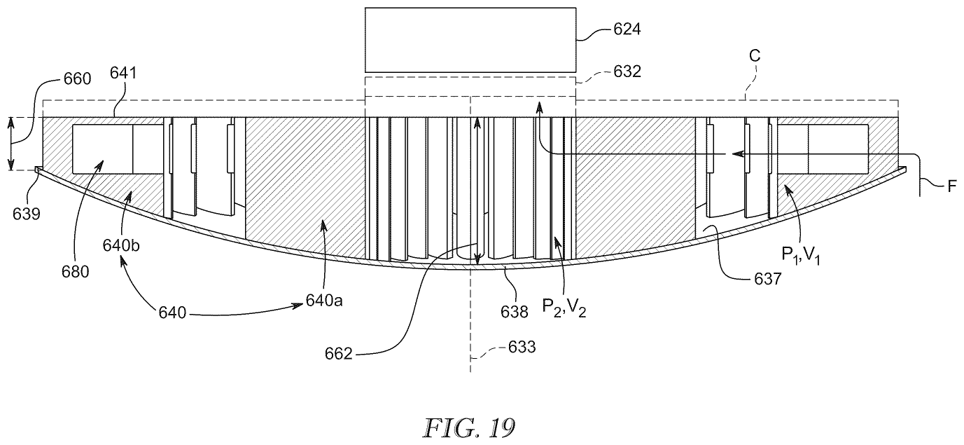

The grille 618 includes a dome-shaped panel 638 and the plurality of acoustic bodies 640 coupled to an upper surface 637 of the dome-shaped panel 638 as shown in FIGS. 18 and 19. The dome-shaped panel 638 is imperforate such that no air can flow therethrough. Each of the acoustic bodies 640 is formed integrally with the dome-shaped panel 638 and are extend upwardly toward the main housing 614 and toward the blower assembly 624. When the ventilation assembly 610 is fully installed, the plurality of acoustic bodies 640 may optionally contact the ceiling C to block airflow above the acoustic bodies 640 and so that airflow occurs only between the acoustic bodies radially inward toward a central axis 633 of the grille 618.

The acoustic bodies 640 are spaces apart circumferentially about the central axis 633 from one another and form an exemplary arrangement of the acoustic features 644 that illustratively includes a pair of acoustic bodies 640, including an inner acoustic body 640a and an outer acoustic body 640b, although in some embodiments, the acoustic features 644 may include any suitable number of acoustic bodies 640 in forming phononic crystals. For example, an acoustic feature 644 may include only one or three, four or more radially spaced acoustic bodies 640. Thus, the terms “inner” and “outer” when applied to acoustic bodies 640 are relative and are not to be interpreted as “innermost” and “outermost” unless context dictates otherwise.

The inner and outer acoustic bodies 640a, 640b are aligned circumferentially about the central axis 633 and spaced radially from the central axis 633 in the illustrative embodiment. Each of the acoustic bodies 640 has an elliptical shape with a centerline that extends through the central axis 633, however, as described in other embodiments herein, one or more of the acoustic bodies 640 can have other suitable shapes including a circular shape.

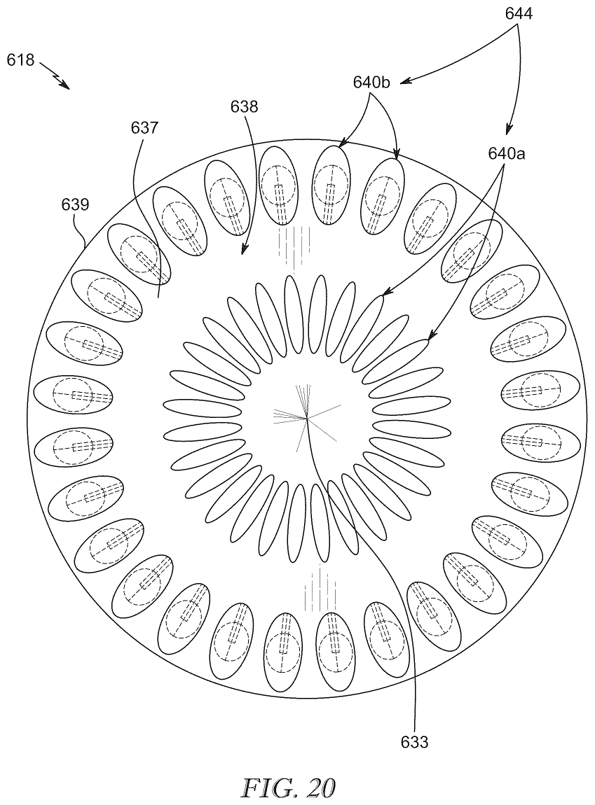

Referring to FIG. 20, the outer acoustic bodies 640b have a larger cross sectional area compared to the inner acoustic bodies 640a, however, a radial length of each acoustic body 640 may be substantially or approximately the same (i.e. within 5% of each other). Additionally, circumferential spacing between the outer acoustic bodies 640b is greater than circumferential spacing between the inner acoustic bodies 640a. The outer acoustic bodies 640b are spaced slightly inward from an outer edge 639 of the dome-shaped panel 638.

Referring to FIG. 21, a height of each of the acoustic bodies 640 varies as the acoustic bodies 640 extend radially inward toward the central axis 633. Illustratively, the outer acoustic bodies 640b have a first height 670 at a radially outer end thereof and a second height 672 at a radially inner end thereof. Likewise, the inner acoustic bodies 640a have a third height 674 at a radially outer end thereof and a fourth height 676 at a radially inner end thereof. The heights 670, 672, 674, 676 progressively get larger due to the shape of the dome shaped panel 638.

The structure of the grille 618 and ductwork (i.e. adaptor 632 or other structure of main housing 614 leading to the fan 626) leading to the fan 626 defines an expansion chamber that reduces sound produced by the ventilation assembly 610 during operation. The dome-shaped panel 638 slopes downwardly toward the central axis 633 to provide the upper surface 637 with a concave shape relative to the ductwork 632. The concave upper surface 637 and the ceiling C cooperate to define a flowpath that leads to the ductwork for an airflow F to flow vertically therebetween as shown in FIG. 19.

The upper surface 637 is spaced a first distance 660 from an upper end 641 of each of the acoustic bodies 640 and the ceiling C at an outer peripheral edge 639 of the dome-shaped panel 638. The upper surface 637 is spaced a second distance 662 from the upper end 641 and the ceiling C at the central axis 633. The second distance 662 is greater than the first distance 660 to provide a greater volumetric space between the dome-shaped panel 638 and the ceiling C the closer to the central axis 633. This volumetric change provided by the dome-shaped panel 638 causes the airflow to decrease in pressure from a first pressure P₁ closer to the outer edge 639 to a second pressure P₂ closer to the central axis 633. This volumetric change provided by the dome-shaped panel 638 also causes the airflow to decrease in velocity from a first velocity V₁ closer to the outer edge 639 to a second velocity V₂ closer to the central axis 633. These changes in pressure and/or velocity contribute to decreasing sound produced by the ventilation assembly 610.

It should be noted that while the dome-shaped panel 638 is used in the illustrative embodiment, in other embodiments, the expansion chamber effect may be produced by other panels having other shapes. Such shapes may include a conical structure, for example. Additionally, in other embodiments, the expansion chamber effect may occur as a result of increasing distance between the panel 638 from the outer edge 639 to the central axis 633 followed by a decrease in volumetric area in the ductwork leading to the fan 626.

In the ventilation assembly 610, each of the outer acoustic bodies 640b is configured to provide a resonator 680 that assists in attenuating sounds produced by the ventilation assembly 610 during operation as shown in FIGS. 21 and 22. Each resonator 680 is illustratively a Helmholtz resonator that is defined by interior surfaces of each outer acoustic body 640b that provide a neck region 682 and a body region 684 as shown in FIG. 22. The neck region 682 opens toward the central axis 633 and, thus, is formed in a radially inner end of each of the outer acoustic bodies 640b. The body region 684 is formed directly radially outward from the neck region 682 in fluid communication with the neck region 682. The body region 684 has a circular or oval shape with an overall volume that is less than each outer acoustic body 640b.

Although the present disclosure illustrates resonators 680 on each outer acoustic body 640b, it should be appreciated that only some of the outer acoustic bodies 640b may be formed to include a resonator 680. In some embodiments, resonators 680 may also be formed in one or more inner acoustic bodies 640a.

The resonators 680 may be tuned by adjusting various dimensions of the neck region 682 and/or the body region 684. Each resonator may be tuned according to the following formula:

$$f = \frac{c}{2 π} \sqrt{\frac{Scol}{Lcol * V}}$$

In the formula above c is the sound speed (m), Scol is a cross sectional area of the neck region 682 (m²), Lcol is a length of the neck region 682 (m), V is a volume of the body region 684 (m³), and f is frequency (Hz). A specified length (Lcorrected) of the neck region 682 may be calculated to target a predetermined frequency according to the following formula:

$$Lcorrected = L c o l + 0.48 * \sqrt{S c o l}$$

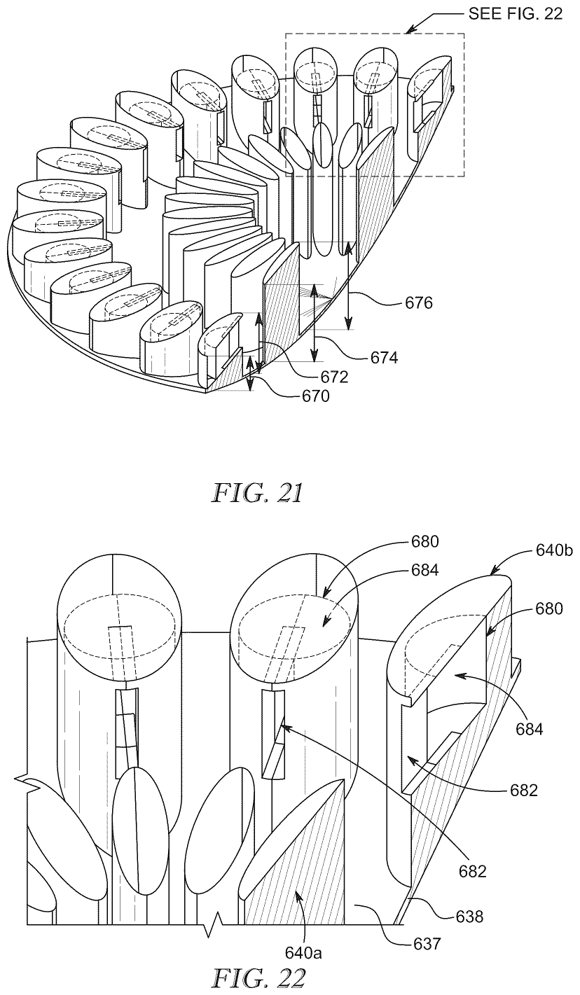

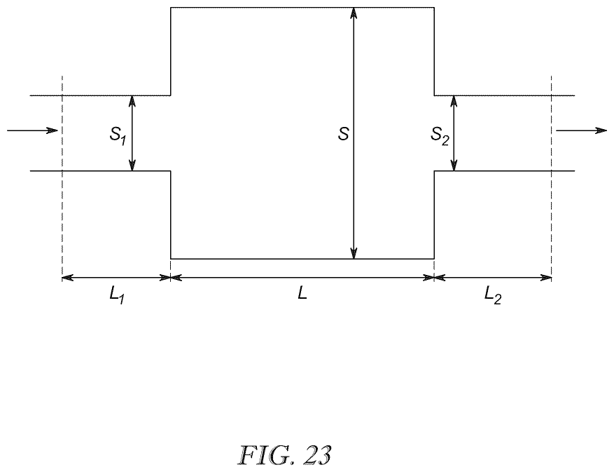

A simplified schematic view of an expansion chamber is shown in FIG. 23. The shape of the grilles 518, 618 provide similar volumetric changes to those shown in the simplified schematic of FIG. 23. Accordingly, in some embodiments, the expansion chamber effect may be realized by the following formulas with reference to the schematic of FIG. 23:

$$T L = 10 * {log}_{10} ( 1 + 0.25 * {( \frac{m - 1}{m} )}^{2} ) * ( sin {( \frac{2 * π * f}{c * Leff} )}^{2} )$$

$$Leff = L + \frac{H}{2} * ( 1 , 7 - ( \frac{0 , 7}{{e}^{m}} ) )$$

In the formulas above, TL is noise transmission loss, m is a ratio of the surfaces (S1²/S2²), c is celerity (m/s), f is frequency (Hz), H is a height of the expansion chamber (S), and L is a length of the expansion chamber (m).

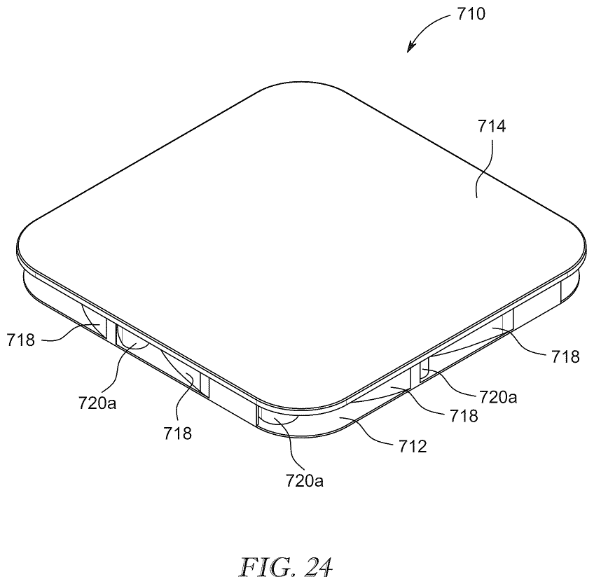

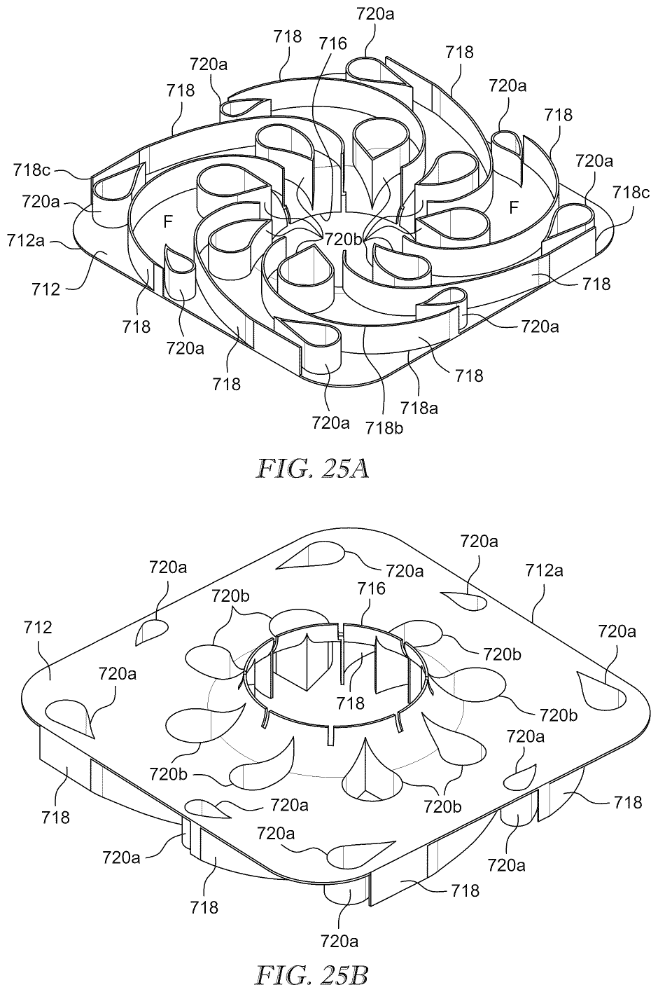

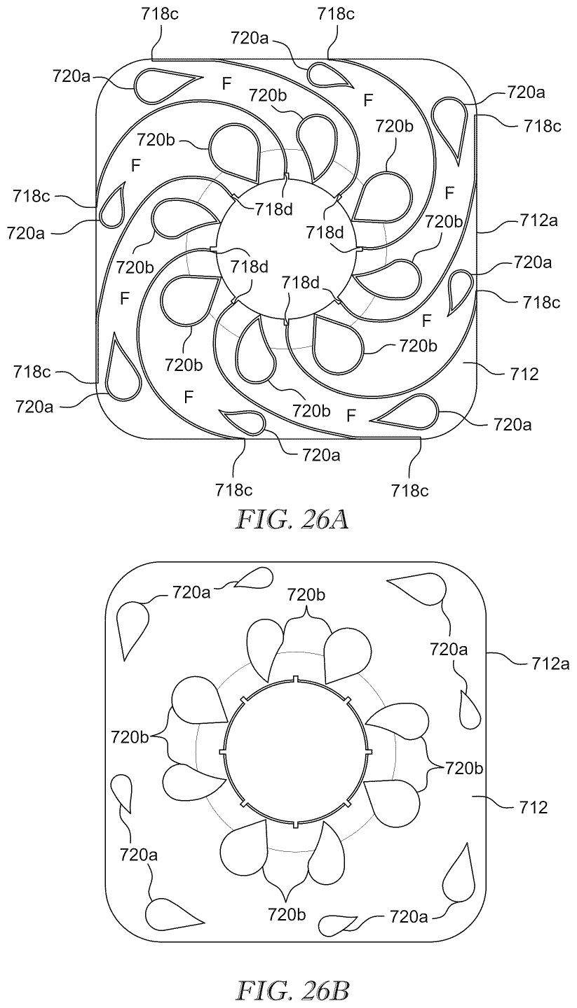

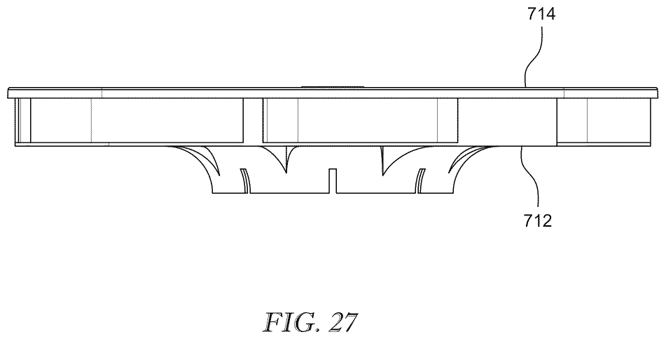

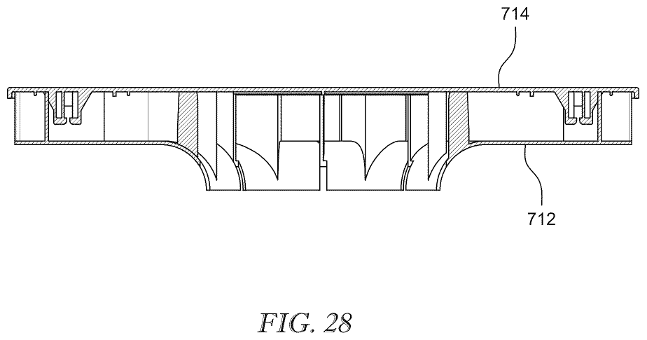

FIGS. 24-28 depict another grille 710 for ventilation assembly according to the present disclosure. The grille 710 has a top plate 712 and a bottom plate 714. The top plate 713 defines an outlet aperture 716 through which air can move from the grille 710 to an associated fan housing (e.g. fan housing 26). The outlet aperture 716 is depicted as annular, but other shapes are also contemplated. The bottom plate 714 is depicted as flat and square with rounded edges, but other shapes are also contemplated. In the depicted embodiment, the bottom plate 714 has no lighting or other accessories, but may, in other embodiments, include any accessories.

The top plate 712 is separated from the bottom plate 714 by a plurality of guide vanes 718 and acoustic bodies 720 spacing the top plate 712 from the bottom plate 714. In one embodiment, the top plate 712 and the bottom plate 714 are approximately parallel to one another so that the spacing between the top plate 712 and the bottom plate 714 is approximately consistent across the grille 710. In the depicted embodiment, the guide vanes 718 extend from the top plate 712 from a top edge 718a to a bottom edge 718b which abuts the bottom plate 714 when the grille 710 is fully assembled. Alternatively, any number of one or both of the guide vanes 718 and the acoustic bodies 720 can extend from the bottom plate 714. The guide vanes 718 extend from an outer end 718c located at or adjacent to an outermost edge 712a of the top plate 712 to an inner end 718d located at or adjacent to the outlet aperture 716. In the depicted embodiment, the guide vanes 718 extend from the outer end 718c to the inner end 718d in a curvilinear manner. In one embodiment, one or more of the guide vane outer ends 718c can extend approximately parallel to the top plate outermost edge 712a. In one embodiment, one or more of the guide vane inner ends 718d can extend perpendicular to the top plate outlet aperture 716.

Each adjacent pair of guide vanes 718, in conjunction with adjacent portion of the top plate 712 and bottom plate 714 define a flow channel F through which air can flow. In the depicted embodiment of a grille for a ventilation fan, air can be drawn from the top plate outermost edge 712a, through the flow channel F and out of the grille 710 through the outlet aperture. Because the guide vanes 718 extend curvilinearly from the top plate outermost edge 712a to the outlet aperture 716, the flow channels F are also curvilinear. Without the presence of the guide vanes 718, air drawn through the grille 710 would typically take an approximate straight path from the top plate outermost edge 712a to the outlet aperture 716. Thus, by providing curvilinear guide vanes 718, the grille 710 creates a longer flow path for air flowing from the top plate outermost edge 712a to the outlet aperture 716. In some embodiments, the guide vanes 718 are configured such that the length of all flow paths F are the same. In other embodiments, the guide vanes 718 are configured such that the flow paths F have different lengths.

One or more acoustic bodies 720 may optionally be placed in one or more of the flow channels F. In the depicted embodiment, an outer acoustic body 720a is located adjacent to the plate outermost edge 712 of each flow channel F and an inner acoustic body 712b is located adjacent the outlet aperture 716. The outer and inner acoustic bodies 720a/b define an acoustic feature 724. One or more of the flow channels F may comprise a greater or lesser number of acoustic bodies 720 or acoustic features 724. One or more of the outer acoustic bodies 720a can be located further inward of the outermost edge 712a of the top late 712. One or more of the inner acoustic bodies 720b can be located further outward on the top plate 712 from the outlet aperture 716. Each acoustic body 720 defines an outer perimeter 722 which defines a shape of the acoustic body 720. In the depicted embodiment, the acoustic bodies 720 define a tear-drop shape to reduce aerodynamic drag created by the acoustic bodies 720. As discussed elsewhere in this disclosure, the acoustic bodies 720 can define any number of other various shapes. As also discussed elsewhere in this disclosure, the acoustic bodies 720 can be hollow or filled and can be comprised of various known materials.

The longer flow path F created by the curvilinear guide vanes 718 allow the outer acoustic body 720a of any such flow path F to be spaced a greater distance from the inner acoustic body 720b of that flow path F than if the curvilinear guide vanes 718 were not present. As discussed elsewhere in this disclosure, the distance between the acoustic bodies 720 can impact the sound reducing capacity of the acoustic features 724 formed by those acoustic bodies 720 and the longer flow path F provides additional options for sizing and spacing of acoustic bodies 720 to define the acoustic features 724. In one embodiment, the longest distance between the outer and inner acoustic bodies 720a/b, defined elsewhere in this disclosure as gap G, is half the acoustic wave length sought to be reduced, dampened or cancelled out.

As discussed elsewhere in this disclosure, the width of the frequency band gap and the sound attenuation level are linked to the filling ratio r of the acoustic body 720 to its elementary cell according to the relationship

$$r = \frac{S c}{S e} ,$$

where S_{c} is 2-dimensional area defined by the perimeter 722 of the acoustic body 720, and S_{c} is the 2-dimensional area defined by the elementary cell. In the embodiment depicted in FIGS. 24-28, the 2-dimensional area defined by the elementary cell is the width of the flow channel F, which is the distance between the guide vanes 718. The filling ratio r is therefore the ratio of the width of the acoustic body 720 to the width of the flow channel F where the guide vanes 718 are present to define a flow channel F. The size and location of the acoustic bodies 720 can be varied to accommodate the length and width of the flow paths F while achieving the maximum possible attenuation.

It should be noted that the various components and features described above can be combined in a variety of ways, so as to provide other non-illustrated embodiments within the scope of the disclosure. As such, it is to be understood that the disclosure is not limited in its application to the details of construction and parts illustrated in the accompanying drawings and described hereinabove. The disclosure is capable of other embodiments and of being practiced in various ways. It is also to be understood that the phraseology or terminology used herein is for the purpose of description and not limitation.

Although the present disclosure has been described in the foregoing description by way of illustrative embodiments thereof, these embodiments can be modified at will, without departing from the spirit, scope, and nature of the subject disclosed.

We claim:

1. A ventilation system comprising:
a main housing defining an inlet through which air can be received into the main housing and defining an outlet;
a blower in the main housing operable to generate a flow of air;
a grille configured to be located adjacent to the main housing inlet, the grille comprising
a plate having an outermost edge, wherein the plate defines an outlet aperture;
a pair of guide vanes extending from adjacent to the outermost edge of the plate toward the outlet aperture, the guide vanes defining a flow path;
an outer acoustic body located in the flow path and an inner acoustic body located in the flow path.

2. The ventilation system of claim 1, wherein the outer acoustic body is located adjacent to the plate outermost edge.

3. The ventilation system of claim 1, wherein the inner acoustic body is located adjacent to the outlet aperture.

4. The ventilation system of claim 1, wherein the outer acoustic body and the inner acoustic body define an acoustic feature.

5. The ventilation system of claim 4, wherein the acoustic feature is a phononic crystal.

6. The ventilation system of claim 1, wherein at least one of the guide vanes defines a curvilinear path from the plate outermost edge to the outlet aperture.

7. A grille for a ventilation system, the grille comprising:
a plate having an outermost edge, wherein the plate defines an outlet aperture;
a pair of guide vanes extending from adjacent to the outermost edge of the plate toward the outlet aperture, the guide vanes defining a flow path;
an outer acoustic body located in the flow path and an inner acoustic body located in the flow path.

8. The grille of claim 7, wherein the outer acoustic body is located adjacent to the plate outermost edge.

9. The grille of claim 7, wherein the inner acoustic body is located adjacent to the outlet aperture.

10. The grille of claim 7, wherein the outer acoustic body and the inner acoustic body define an acoustic feature.

11. The grille of claim 10, wherein the acoustic feature is a phononic crystal.

12. The grille of claim 7, wherein at least one of the guide vanes defines a curvilinear path from the plate outermost edge to the outlet aperture.

13. A grille for a ventilation system, the grille comprising:
a top plate having an outermost edge, wherein the top plate defines an outlet aperture;
a bottom plate;
a pair of guide vanes extending between the top plate and the bottom plate and defining a flow path; and
an outer acoustic body located in the flow path and an inner acoustic body located in the flow path.

14. The grille of claim 13, wherein the outer acoustic body is located adjacent to the outermost edge of the top plate.

15. The grille of claim 13, wherein the inner acoustic body is located adjacent to the outlet aperture.

16. The grille of claim 13, wherein the outer acoustic body and the inner acoustic body define an acoustic feature.

17. The grille of claim 16, wherein the acoustic feature is a phononic crystal.

18. The grille of claim 13, wherein at least one of the guide vanes defines a curvilinear path from the plate outermost edge to the outlet aperture.

19. The grille of claim 13, wherein the acoustic bodies extend between the top plate and the bottom plate.

20. The grille of claim 13, wherein the acoustic bodies extend from the top plate.
